(19) United States
(12) Patent Application Publication
(10) Pub. No.: US 2009/0089293 A1
(43) Pub. Date: Apr. 2, 2009

(54) SELFISH DATA BROWSING

(75) Inventors: Carlos P. Garritano, Cleveland, OH (US); Bradley D. Chase, Cleveland, OH (US)

Correspondence Address: Carlos P. Garritano, 2141 W. 47th St., Cleveland, OH, 44102, US

(73) Assignee: BCCG VENTURES, LLC, Cleveland, OH (US)

(21) Appl. No.: 11/864,454

(22) Filed: Sep. 28, 2007

(51) Int. Cl. G06F 7/00

(52) U.S. Cl. 707/10

(57) ABSTRACT

The claimed subject matter provides a system and/or a method that facilitates accumulating a portion of data associated to an interest. An interface component can receive a portion of data actively and explicitly selected by an input device during a browsing session, wherein the selection is indicative of an interest experienced during the browsing session. An aggregator component can copy the portion of data upon active and explicit selection in which the portion of data is accumulated as a collection representative of the interest. A filter component can manipulate the browsing session to emphasize a portion of data based on having relevancy to the collection representative of the interest.

### BACKGROUND

Technological advances associated with computers, the Internet and the World Wide Web have enabled users to instantly access a vast and diverse amount of information. As compared to traditional libraries or encyclopedias, information provided by way of the Web is decentralized in nature. Furthermore, computer and networking advancements have transformed computers from rare, expensive, and low performance data processing machines to commonplace, low-cost, and efficient tools. These technological evolutions have further contributed to the constant and rapid growth of electronic data. For example, users typically access and/or view massive amounts of data while using a computer (with or without the Internet, networking, third-party networked services, etc.) such as web sites, forums, email, images, web services, web applications, video files, audio files, instant messaging services, documents, presentations, and the like.

For example, to locate information of interest, a user can employ a search engine that facilitates finding content stored on local or remote computers. Search engines can assist in locating information on the public Web, intranets, personal computers, and the like. Typical search engines can retrieve a list of references (e.g., search results) matching inputted criteria provided by the user. For instance, the user can perform a query by providing a word or phrase to the search engine and in response the search engine can return a list of search results matching the entered word, phrase, or a portion thereof.

As the amount of available electronic data grows (e.g., email, voice, audio, video, text, web pages, images, web services, applications, etc.), it becomes more difficult to store, organize, or use such data in a manageable manner that facilitates user-friendly and quick data searches and retrieval. Adding to these manageability issues is the vast amount of data stored locally (e.g., low-cost, high-capacity hard drives, flash memory, recordable media, re-writable media, compact discs, etc.) and remotely (e.g., web pages, web sites, web services, web servers, etc.) which can convolute a data browsing experience and distract a user from viewing or accessing data that he or she desires.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate accumulating data of interest based upon an active and explicit selection to enhance data browsing. An aggregator component can accumulate and receive actively and explicitly selected data via an interface, wherein the active and explicit selection can be indicative of being relevant to a purpose or interest during a browsing session. For instance, a user can knowingly and purposefully select a portion of data during a browsing session once such data has been determined to appeal to such user. Thus, the aggregator component accumulates such actively and explicitly selected data during a browsing session as a collection representative of an interest or a browsing purpose.

The claimed subject matter can further employ a filter component. The filter component can evaluate the actively selected data in order to ascertain at least one defining characteristic reflective of an interest, appeal, or browsing purpose. For instance, the filter component can examine identifying data related to the selected data such as metadata, tags, any data visible or non-visible to an end user, any data embedded in a format of the data, etc. The filter component can further emphasize a portion of data within or associated with the browsing session based at least in part upon the selected data and identified interest, appeal, or browsing purpose. In other words, the actively selected data can be utilized to identify particular topics, subjects, information, etc. that is of interest or appealing and the browsing session can be enhanced such that relevant data can be emphasized. Thus, the emphasized data can be relevant to the active and explicit data selections, therefore allowing a browsing session to be more efficient since relevant data is accentuated. In other aspects of the claimed subject matter, methods are provided that facilitate leveraging actively and explicitly selected collections of data to enhance future data browsing or exploration.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates accumulating data of interest based upon an active and explicit selection to enhance data browsing.

FIG. 2 illustrates a block diagram of an exemplary system that facilitates arranging and/or formatting a collection of data that represents an explicit interest.

FIG. 3 illustrates a block diagram of an exemplary system that facilitates leveraging actively and explicitly selected collections of data to enhance future data browsing or exploration.

FIG. 4 illustrates a block diagram of an exemplary system that facilitates implementing a user profile that is device agnostic in accordance with the subject innovation.

FIG. 5 illustrates a block diagram of an exemplary system that facilitates tracking data actively selected and configuring various settings in accordance with the claimed subject matter.

FIG. 6 illustrates a block diagram of an exemplary system that facilitates leveraging an inference technique to optimize employment of actively and explicitly selected data.

FIG. 7 illustrates an exemplary methodology that facilitates capturing data in an original form with an active and explicit selection to dynamically identify user interests associated with data browsing.

FIG. 8 illustrates an exemplary methodology for collecting and organizing data of importance with an explicit selection.

FIG. 9 illustrates an exemplary methodology that facilitates managing a data browsing session towards an interest of a particular user or machine based on previously collected data.

FIG. 10 illustrates an exemplary methodology for dynamically refining a browsing experience based on active explicit identification of user-interested data.

FIG. 11 illustrates an exemplary operating environment that can be employed in accordance with the claimed subject matter.

FIG. 12 illustrates an exemplary networking environment, wherein the novel aspects of the claimed subject matter can be employed.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “device,” “store,” and the like are intended to refer to a computer-related entity, either hardware, software (e.g., in execution), firmware, and/or any suitable combination thereof. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

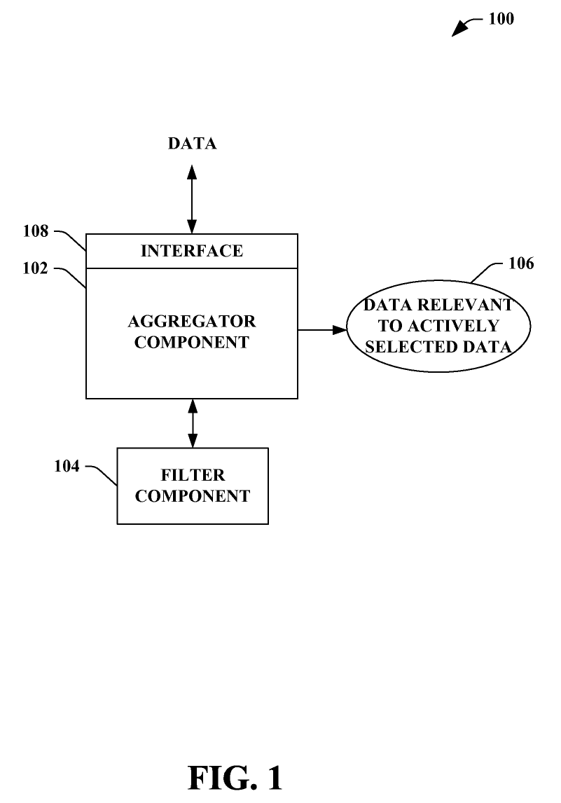

Now turning to the figures, FIG. 1 illustrates a system 100 that facilitates accumulating data of interest based upon an active and explicit selection to enhance data browsing. The system 100 can include an aggregator component 102 that can receive a portion of actively and explicitly selected data via an interface component 108 (discussed in more detail below), wherein the selected data can be utilized by a filter component 104 to identify relevant data (e.g., data relevant to actively selected data 106). In general, the system 100 can collect portions of data to which an interest has been established with active selection and employ such selections to identify additional relevant data (e.g., data relevant to the actively selected data). By employing active and explicit selection of data, such selected data is knowingly flagged as being of interest, relevant, or important (e.g., data being appealing). On the contrary, typical and conventional techniques assume that perusing, browsing, or surfing data translates into an interest or satisfaction of a query.

For instance, a user can search the Internet for information related to a particular topic with a search engine. Various searches can return a plethora of results that can overwhelm or distract the user. Thus, users will inevitably peruse or examine the results by clicking, viewing, and the like in order to find or eliminate (e.g., weed out) results. However, conventional techniques assume that this “exploratory” search of data is indicative of the user's interest (e.g., passive activation techniques, click-based search engines, etc.), but not taking into account of whether or not such data has satisfied the user. For example, a link can be returned from a search and a user may quickly view and discard such link demonstrating that the returned result is not relevant to the user. The subject innovation can implement an active and explicit identification of data that can be indicative of pertaining to an interest or being relevant to a browsing session. Thus, a user can be browsing data on a web site during a browsing session and actively and explicitly select a portion of data that is of interest or relevant (e.g., direct or indirect) to such session.

The aggregator component 102 can receive and/or collect any suitable data explicitly selected or identified. For example, the active and explicit selection or identification can be received by a user or a machine, wherein the selection or identification can be any purposeful action (e.g., clicking, designated button inputs from an input device, graphical overlays, eye detection, voice commands, flagging, underlining, highlighting, bolding, font-change, font size, color-change, selection tools, selection modes, touch screens, drag and drop techniques, etc.) that signifies the portion of data correlates to an interest or satisfies a query. In one example, the aggregator component 102 can employ a graphical overlay (e.g., embedded on browsing application, incorporated into toolbar, etc.) that can collect selected data, wherein data can be selected by at least one of a click and drag to the graphical overlay, a right-click for option to place into overlay, etc. It is to be appreciated various techniques (which will be discussed in more detail below) can be implemented in order to actively and explicitly identify data and the subject matter is not limited by such techniques. In other words, the system 100 can utilize any suitable technique to select data as long as the technique correlates to an active, explicit, and purposeful identification of data.

The system 100 enables a browsing experience or session for a user to be tailored or trained under their control by utilizing the aggregator component 102 to accumulate pre-established data of interest and/or pre-identified relevant data. It is to be appreciated that the data actively and explicitly selected can be any suitable data explored or browsed such as, but not limited to, a web page, a portion of a web page, a selection of text, a character, a web address, an image, a portion of a graphic, an icon, a uniform resource locator (URL), a web site, a portion of a web site, a portion of handwriting, a portion of a forum, a portion of an email, a portion of a communication session (e.g., text messaging, instant messaging, a chat room, a video chat, a web chat, etc.), audio, video, live feed, a portion of data related to an application, a portion of local data (e.g., personal files, personal data, local network, local machine, local hard drive, etc.), a portion of remote data (e.g., data associated with the Internet, remote networks, etc.), and/or any other suitable data capable of being viewed or displayed. Moreover, it is to be appreciated that the system 100 can be utilized with any suitable device or machine that can browse, store, or explore data such as, but not limited to, a computer, a laptop, a machine, a cell phone, a handheld, a smartphone, a portable digital assistant (PDA), a mobile communication device, a pocket PC, a cellular device, a wireless device, a mobile Internet browsing device, a portable media player, a portable PC, a gaming console, a gaming device, a navigation device, a stereo, a car stereo, an appliance, a music player, a smart device, etc.

The aggregator component 102 can accumulate data purposely and unequivocally selected into a location (e.g., remote or local and discussed in more detail below) such as a virtual white board. The aggregator component 102 can copy selected data in original state, form, and/or file type onto or into the virtual white board as a tabulation of data representative of interest. Since the data can be purposefully identified and pre-explored to ensure it is related to an interest (e.g., relevant, appealing, etc.), the virtual white board can be a highly valuable tool in tailoring browsing sessions in a selfish manner. In other words, the virtual white board can include various data identified during various browsing sessions which can be a record of interest for the user or machine who actively selected such data. The virtual white board can be viewed, displayed, printed, emailed, published, cleared, transmitted, stored, uploaded, downloaded, shared, etc. It is to be appreciated that such data will be much more granular and detailed in comparison to typical “favorites” or “bookmarks” since the original state (e.g., a snapshot of original state, file type, format, location, amount, type of data, etc.) and/or a portion of data (e.g., image, portion of text, a section of a web page, etc.) rather than the entire URL can be copied to the virtual white board. As will be discussed in more detail later, the data collected with the virtual white board generated by the aggregator component 102 can be formatted, organized, communicated, etc. in order to enhance data experiences.

The data collected by the aggregator component 102 can be evaluated and/or examined by the filter component 104. The filter component 104 can examine any suitable characteristics or details related to the actively selected data such as, but not limited to, a tag (e.g., hypertext markup language (HTML), etc.), metadata, web browser add ins (e.g., scripts, coding, etc.), search terms, key words, source of selected data (e.g., web site, web page, address, name, file type, file name, etc.), image data, context, date and time edited, date and time saved, any data visible or non-visible to an end user, any data embedded in a format of the data, etc. In general, the filter component 104 can identify a generalized topic, subject, relationships, associations, etc. related to the selected data to which data within the current or future browsing session can be emphasized and/or manipulated accordingly.

For instance, a user can browse a web page in which a portion of an article can be found to be of interest or to the liking of the user. Since a portion of the article interests the user during the browsing session, the user can actively and explicitly designate such portion of data to the aggregator component 102—signifying that this portion of data has been pre-screened and represents an interest to the user. The aggregator component 102 can copy at least one of the selected portions of the article or a source related to the article (e.g., URL, web site, etc.). Such collected data can be evaluated by the filter component 104 in order to identify relevant data for the current browsing session and/or a future browsing session. Thus, if the filter component 104 ascertained the portion of the article related to a certain car, data relevant to such certain car during the current or future browsing session could be emphasized.

In still another example, the system 100 can be automatically and continuously maintained up-to-date based on the active and explicit selection of data. In other words, the system 100 can be continuously populated with data of interest based on the active selection. For example, most personalized websites initially constrain and force a user to select interests, hobbies, or topics of interest from a rigid list that, if change, need to be re-entered. However, the system 100 eliminates these problems by enabling unconstrained selection of interested data (e.g., not restricted to lists and interested data selection is independent of type, format, source, etc.) and continuous tracking of an interest with active, explicit selection.

In still another example, the system 100 can be utilized in identifying a portion of data actively and explicitly selected as not satisfying an interest, purpose, or a search query. For instance, a user can actively and purposely select data that the does not appeal or is of no interest to the user. Thus, the system 100 can automatically evaluate such actively and explicitly selected data to emphasize and/or enhance a browsing session. In particular, data that is relevant to the selected that is of no interest to the user can be blocked or de-emphasized (e.g., smaller font, blocked, eliminated, shrunk, blurred, etc.).

In yet another aspect of the subject innovation, the active and explicit selection of data can be ranked by the user in order to specify an amount of interest (e.g., relevancy, appeal, satisfaction, etc.) or disinterest (e.g., irrelevancy, non-appealing, dissatisfaction, etc.). Thus, upon an active and explicit data selection, a user can rank on any suitable scale the degree to which such data should be weighted, ranked or utilized in identifying relevant data within a browsing session. In other words, the user can define an amount of influence a particular active and explicit selection can have for emphasizing on a browsing session.

Moreover, the system 100 can include any suitable and/or necessary interface component 108 (herein referred to as “interface”), which provides various adapters, connectors, channels, communication paths, etc. to integrate the aggregator component 102 into virtually any operating and/or database system(s). In addition, the interface 108 can provide various adapters, connectors, channels, communication paths, etc., that provide for interaction with the aggregator component 102, the filter component 104, the data relevant to actively selected data 106, and/or any other device, network, server, user, and/or component associated with the system 100.

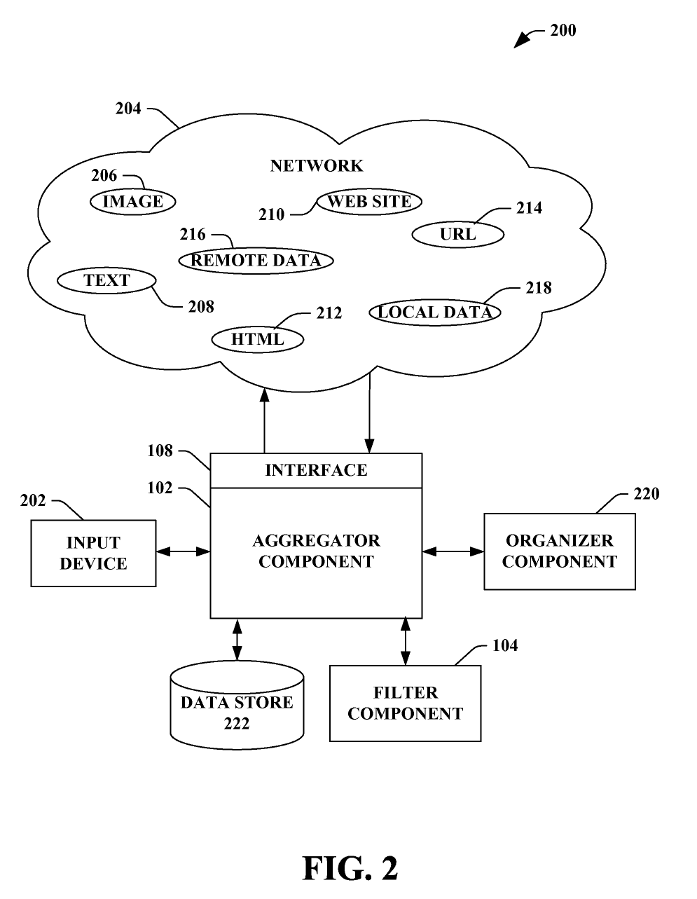

FIG. 2 illustrates a system 200 that facilitates arranging and/or formatting a collection of data that represents an explicit interest. The system 200 can include the aggregator component 102 that can amass a collection of data representative of interest based on active, purposeful, and explicit selection. An input device 202 can be employed to designate a portion of data as having a proven interest to a user, a machine, and/or a browsing session. For instance, the input device 202 can identify data with a designated button input such as a double-click, a specialized button input, a right-clickable option, a click-and-drag to a graphical overlay, a highlight, an underline, a selection, a touching input from a touch screen, a touching, a voice input, a motion detected from a user (e.g., retina movement detection, body part motion, etc.), and/or any other suitable input that can discern such input as designation to represent an interest. The input device 202 can be, but is not limiting to being, a mouse, a trackball, a voice receiver/component (e.g., utilizing a voice command to select data), an eye detection component/receiver (e.g., detecting a selection of data based on eye movement), a touch-screen, a keyboard, a keypad, a joystick, a movement sensor/component (e.g., utilizing a body movement to select data), a proximity sensor (e.g., based on time, temperature, data change speed, etc.), global positioning sensor (GPS), and/or any suitable device capable of identifying an active selection of data.

The input device 202 can actively identify data from a network 204 for collection by the aggregator component 102. The network 204 can be, for instance, a remote network, a local network, a Wide area network (WAN), a Local area network (LAN), a wireless network (e.g., wireless fidelity (Wi-Fi), radio frequency identification (RFID), Bluetooth, near field communication (NFC), satellite, microwave, UHF, VHF, etc.), a wired network, the Internet, Internet2, a cloud, and/or any network capable of browsing, exploring, or viewing data. The cloud can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). As discussed, the aggregator component 102 can collect any data actively and explicitly selected (e.g., via the input device 202) regardless of type, format, location, size, etc. Thus, the network 204 can be explored and/or browsed during, for instance, a browsing experience or session, in which various portions of data can be selected to indicate an interest. The network 204 can include data that can be selected and aggregated to define emphasis of relevant data, wherein the data can be, but is not limited to, a portion of an image 206, a portion of text 208, a portion of a web site 210, a portion of hypertext markup language (HTML) 212, a portion of a programmable language (e.g., HTML, SOAP, ladder logic, extensible markup language (XML), C, C #, C+, C++, PASCAL, LISP, COBAL, FORTRAN, etc.), a portion of a URL 214, a portion of remote data, and/or a portion of local data 218. It is to be appreciated that the network 204 can include various amounts and types of data but is not depicted for the sake of brevity.

For example, a user can utilize a browser to explore data on the Internet. If the user comes across a portion of data that interests him/her, such data can be indicated with an active and explicit selection or identification by the input device 202. For instance, if the user is browsing a news web page and an image of a sunset is liked, such image can be actively selected. Such selected data can be utilized to emphasize relevant data in a current or future browsing session. Thus, while browsing data on the Internet, emphasis can be given to an image with a sunset, an article describing the best sunset locations, a weather report indicating when sunsets occur, etc. In another example, the user can explore a local hard drive in which pictures and/or images can be viewed. Based on the actively selected “sunset” topic or subject, pictures and/or images with a sunset can be emphasized on the local hard drive. Thus, it is to be appreciated and understood that the subject innovation can be utilized with data actively selected in a remote setting, a local setting, and/or any suitable combination thereof Moreover, as will be discussed in more detail below, such local and/or remote settings can be adjusted and/or defined based on preference.

The system 200 can further employ an organizer component 220 that can facilitate arranging data that has been actively and overtly designated as being of interest and/or satisfying a query. The aggregator component 102 can accumulate data that has been purposely and actively identified, wherein such identification is indicative of an interest or a satisfaction of a query or browsing session. As discussed, the data selected can be copied by the aggregator component 102 into and/or onto a virtual white board. The aggregator component 102 can copy selected data in original state, form, and/or file type onto or into the virtual white board as a tabulation of data representative of interest. Moreover, the virtual white board can be viewed, displayed, cleared, transmitted, stored, uploaded, downloaded, shared, etc. in order to provide various reflections of one's actively and purposefully identified data-agnostic interests. In order to optimize use of the collected data, the organizer component 220 can provide data arrangement in accordance with defined settings (discussed below). Moreover, the organizer component 220 can format the collected data into various formats.

In general, the organizer component 220 can uniformly format and/or arrange the actively collected data. For instance, the virtual white board data (e.g., the selected data) can be formatted to be converted into various data representations such as, but not limited to, a URL, a thumbnail, an icon, a web address, a web page, an image, a slide show, a word processing document, a presentation, an application specific file type (e.g., a portable document format (PDF), etc.), an email attachment, a text message, a short messaging service (SMS) message, an instant message, a compressed file package, a portion of video, a portion of audio, a downloadable file format, a voicemail, and/or any suitable combination thereof. It is to be appreciated that the organizer component 220 can employ various data conversion techniques to convert a first data file type (e.g., the originally actively selected portion of data) to a second data file type. For example, a portion of text accumulated with the aggregator component 102 can be converted into audio by translating the text into audio. In another example, a selection of a URL for a website can be converted into a thumbnail or screen shot of the web site—providing a viewable virtual white board rather than a readable one. Thus, the organizer component 220 can employ any data selected from its original state, format, and/or type into another state, format and/or type.

Moreover, the organizer component 220 can provide aesthetic configurations for the various data representations. In other words, for the various data representations or original representations in which data is collected, the organizer component 220 can implement respective settings and/or configurations. For instance, the organizer component 220 can manage configurations such as font (e.g., Times New Roman, Arial, etc.), font size (e.g., 12 pt., 10 pt, etc.), data color, page layout (e.g., margins, headers, footers, paragraph settings, spacing, outline format, roman numeral format, numbering options, page numbers, etc.), display options for actively selected data (e.g., view in original captured form, display data as thumbnail representations, etc.), layout settings (e.g., data appearance, arrangement of data, etc.), communication/transfer options (e.g., recipients, size limitations, subject line, email server, address selection, etc.), active links, non-active links, image/graphic size (e.g., mega pixel, etc.), options for an application specific program (e.g., presentation-template selection, layout of presentation, etc.; email-attachment size, recipients, subject, etc.; slideshow-size on slide, amount on slide, format of slide, layout, font, etc.; video-frame rate, quality, etc.; and the like), file size limitations (e.g., maximum, minimum, etc.), and/or any other suitable option related to a data representation. For example, if the organizer component 220 converts a portion of text into audio, the organizer component 220 can further ensure the audio file is a particular file type, of a certain size, with a particular quality, and a specific naming convention. In another example, if the data collected is formatted into a presentation data representation, the organizer component 220 can employ a page layout, font size, headers, topic headings, data layout, bullets, templates, styles, borders, shading, etc. In still another example, the data actively and explicitly selected on the virtual white board can be maintained in its original captured form and communicated by the organizer component 220 with settings such as recipients, manner of transmission (e.g., email, text, instant message, voice, etc.), size, etc.

The system 200 can further include a data store 222 that can include any suitable data related to the aggregator 102, the filter component 104, the input device 202, the network 204, the organizer component 220, etc. For example, the data store 222 can include, but not limited to including, actively and explicitly identified data, organizer component 220 settings/options (e.g., data representations, organization settings, etc.), data conversion techniques, topics or subjects generalized by the filter component 104, virtual white board data, settings related to capturing data (e.g., active and explicit data selection options), input device options/settings, user preferences, user settings, user profiles (discussed in more detail below), extracted data evaluated by the filter component 104 (e.g., tags, metadata, search terms, key words, source of selected data, image data, context, etc.), and/or any other data related to the system 200.

It is to be appreciated that the data store 222 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 222 of the subject systems and methods is intended to comprise, without being limited to, these and any other suitable types of memory. In addition, it is to be appreciated that the data store 222 can be a server, a database, a hard drive, a pen drive, an external hard drive, a portable hard drive, and the like.

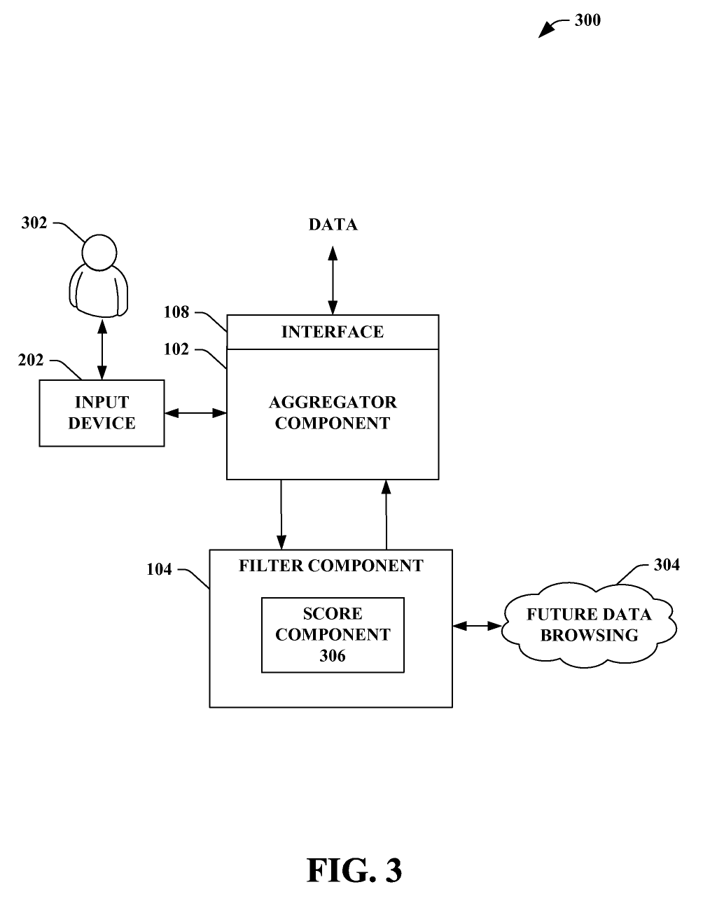

FIG. 3 illustrates a system 300 that facilitates leveraging actively and explicitly selected collections of data to enhance future data browsing or exploration. The system 300 can include the aggregator component 102 that can collect actively and explicitly identified portions of data that are purposefully selected based on satisfying a query or an interest. The collected data can be evaluated by the filter component 104 in which to manipulate and/or enhance data browsing (e.g., a computing session in which data can be explored, viewed, displayed, and/or utilized). As discussed, a portion of data can be designated with the input device 104. For instance, a mouse can employ an interest-highlight (e.g., entering a data selection mode for selection, a designated button activation after highlight, etc.) to select a portion of data on a browsed web page, wherein based on such interest-highlight the aggregator component 102 can collect the selected portion of data to enable the filter component 104 to enhance a browsing session by emphasizing relevant data to such selection.

The input device 202 can be utilized by a user 302, for example. The user 302 can interact with the input device 202 in order to purposefully select data to which satisfies an interest or a query after explicitly determining the data has relevance. For instance, a user can search emails with a particular query and receive results. The user 302 can actively select and identify specific emails that accurately satisfied the query and such data can be collected by the aggregator component 102 as data that satisfies an interest and/or a query. By allowing the user 302 to “weed out” inaccurate results with active and explicit identification, the system 300 can enhance data browsing, search, and/or data experiences in general. Moreover, it is to be appreciated that the system 300 can be automated in which a machine or computer can interact with the input device 202 for active and explicit data selection.

The filter component 104 can emphasize a portion of a current or future browsing session by evaluating the data purposely and actively selected in which such evaluation can produce generalized topics and/or subjects of interest to the user 302. In general, the data actively selected establishes a clearly defined trust that such data satisfies the user 302 (e.g., satisfaction of a query or an interest). By aggregating data designated as representative of the user's 302 interest, the filter component 104 can emphasize particular aspects of a future data browsing 304 related to the user 302. It is to be appreciated that the future data browsing 304 can be within the same session in which data is selected and can be implemented in a dynamic manner (e.g., data browsed, data actively selected, and data browsed is enhanced based on selection). The filter component 104 can optimize the future data browsing 304 by emphasizing at least a portion of data within the browsing session. The emphasis can be, but is not limited to, an exclusion of data (e.g., eliminating data in which no interest is ascertained, etc.), a highlight of data (e.g., color, highlight, shapes encompassing data, glowing, blurring of data, sharpening of data, etc.), an enlargement of data (e.g., font, size, magnification, etc.), a graphic directing attention towards data (e.g., a pop up, an arrow, an icon, a flag, etc.), a refinement of search terms, a refinement and/or adjustment of a query, and/or any other suitable technique that can discern relevant data from non-relevant data in the data browsing session. It is to be appreciated that the original form of selected data can be a characteristic in which data that is to be emphasized can conform toward. For example, if a portion of data in a specific file type is actively and explicitly selected as satisfying an interest, the data emphasized in a browsing session can be restricted to such file type. Thus, if an image is actively selected, relevant data can be emphasized only if it is an image.

The filter component 104 can utilize a score component 306 that can employ a weighting towards generalized topics or subjects in connection with a relevancy. In other words, the score component 306 can utilize a granular weighting technique so relevancy of the subject or topic generalized by the filter component 104 can be measured or implemented to a browsing session in an accurate and relative manner. Since some portions of data may correlate to an interest or query more than others, the score component 306 can account for this by providing granular weighting to at least one of actively selected data, generalized topics, generalized subjects, or emphasized data in a browsing session based on the actively identified data.

For instance, a user can purposefully and knowingly designate five portions of data as satisfying an interest or query in which three portions relate to a video game and two portions relate to a political party (e.g., using the filter component 104 to identify what data relates to such as topic or subject). The score component 306 can provide a heavier weight or ranking to the video game topic since more data has been actively designated by the user. With more weight given to the video game topic (based on more actively selected data), the filter component 104 can emphasize portions of data related to the video game within a browsing session more than portions of data related to the political party.

Furthermore, the score component 306 can employ a distinct score for a portion of data actively selected in which such distinct score can signify that a portion of data has been actively selected by a user. The score component 306 can associate a score in connection with the amount of users or machines that have designated a portion of data as satisfying an interest or query. The score component 306 can further interact with one or more users or machines in order to monitor the amount of active identification of a specific portion of data. Thus, in one example, the score component 306 can communicate with a plurality of users or machines utilizing the system 300 in order to generate a score for a portion of data. For instance, a query from a web search can provide a conventional listing of results that are based on traffic or active clicks. The score component 306 can allow such search results to be ranked in accordance to an “active selection score” tabulated from a plurality of users/machines that have actively selected the portions of data.

The score component 306 can further employ a weight template that can be pre-defined or user-defined. The weight template can define an amount of weight a particular portion of actively selected data or generalized topic/subject should be employed. The weight template can be user-defined, a default setting with user trained capabilities, a smart weight template that trains itself, and/or any combination thereof. For example, a default weight template can be utilized in which a user can edit or tailor specific to their needs. In another example, the weights can be automatically generated as a user designates data as having an interest. In still another example, the weight template can be selected from a list of pre-defined templates that are aimed at specific topics/subjects (e.g., sports, news, weather, geographic-based, electronics, dog pictures, etc.). It is to be further appreciated that the weight template employed by the score component 306 can be utilized with a user profile (discussed in more detail below).

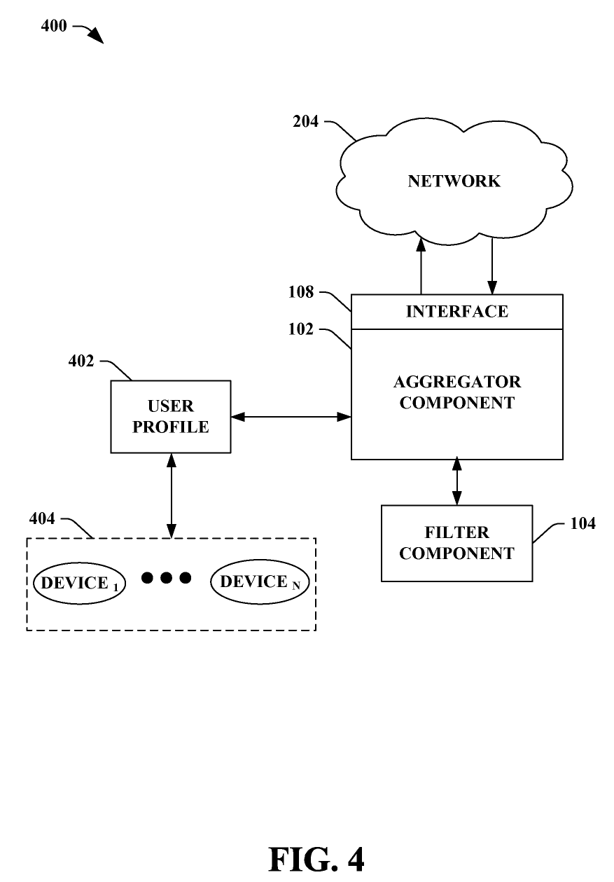

FIG. 4 illustrates a system 400 that facilitates implementing a user profile that is device agnostic in accordance with the subject innovation. The system 400 can include the aggregator component 102 that collects actively identified data from the network 204 in order to manipulate a data browsing session based on evaluation of such data with the filter component 104. The system 400 can further utilize a user profile 402 that can be activated to track and/or monitor user activity for a personalized enhancement of a browsing session. For example, a family of three can browse data with a desktop computer. Yet, active collection of data can be confused from user to user within the family. By implementing a user profile for each user, the system 400 can accurately provide an enhanced browsing session respective to each user.

Additionally, it is to be appreciated that the user profile 402 can be activated on any suitable device in which data can be browsed, explored, displayed, viewed, and the like. The user profile 402 can be associated with a plurality of devices 404 such as device₁ to device_{N}, where N is a positive integer. For example, a user can activate a user profile on a laptop for a first browsing session and activate the user profile on a work computer for a second browsing session, wherein any data actively selected can be collected and utilized to emphasize particular portions of data within a browsing session. In another example, the user profile 402 can include various personas or roles that enable a user to granularly define the user profile 402. For example, a user profile can include a “work” persona/role or a “home” persona/role in which data collection can be tracked accordingly. For instance, the persona/role can be based on a location (e.g., home, work, car, friend's house, a location-tracking determination, GPS, etc.), a time (e.g., last week, Saturday, morning, lunch time, football kickoff, etc.), a season (e.g., spring, sports season, summer, etc.), a device (e.g., portable device, desktop, work machine, home machine, etc.), a network connection (LAN, WAN, wireless, etc.), a server, a connection type (e.g., broadband, wireless, LAN, dial-up, etc.), a connection speed, or a service provider, and/or any other suitable criteria in which a persona can be based.

In another instant, the user profile 402 can be at least one of client-side based, server-side based, and/or any combination thereof. For instance, a user profile can be centrally located on the Internet in order to allow seamless access to track and monitor active and explicit data selections for selfish browsing (e.g., emphasizing particular portions of data based on the actively selected data). Moreover, it is to be appreciated that the user profile 402 and associated data (e.g., actively selected data, generalized topics/subjects, etc.) can be private, public, shared, communicated, etc. In general, it is to be appreciated that the system 400 can be more effective if data actively selected is kept private. However, it can also be stated that the actively selected data can be valuable to particular entities (e.g., web sites, search engines, companies, businesses, advertisements, marketing departments, etc.). Thus, the system 400 enables a private setting, a public setting, and/or any combination thereof. For instance, a collection of data which has been actively selected and accumulated by the aggregator component 102 can include a portion that is private and a portion that is public. Moreover, the system 400 can allow specification on which entities can receive and/or access the actively selected data.

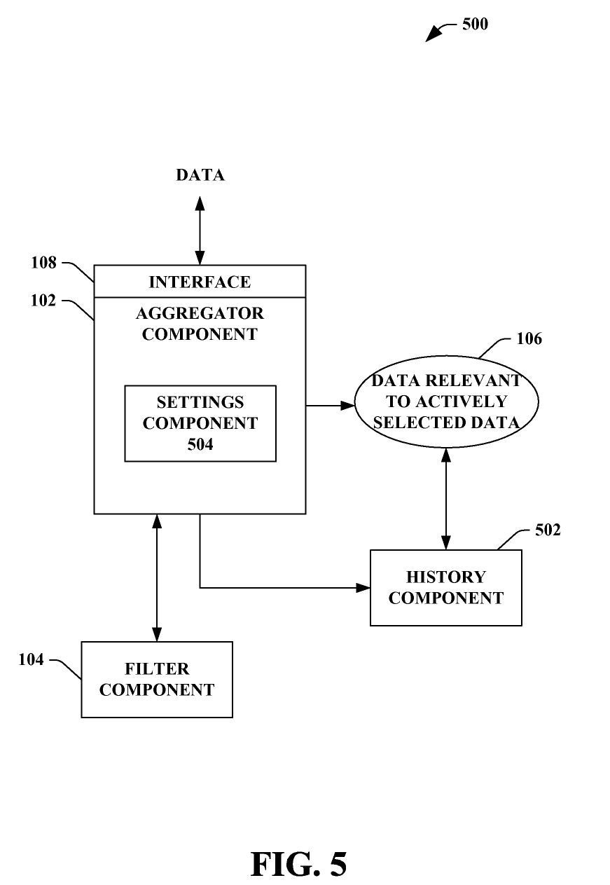

FIG. 5 illustrates a system 500 that facilitates tracking data actively selected and configuring various settings in accordance with the claimed subject matter. The system 500 can include the aggregator component 102 that enhances a browsing session based upon accumulating actively, purposely, and explicitly selected data in which the filter component 104 can utilize to identify data relevant to such actively selected data 106. The aggregator component 102 can further include a history component 502 that can track and/or record any suitable data associated with the system 500. For instance, the history component 502 can log active and explicit data selections, enhancements made to a browsing session, data viewed, data displayed, data identified, data of interest, data relevant to actively selected data 106, correlations identified between actively selected data and enhancements, mappings between enhancements/changes to a browsing session or experience and actively selected data, source of actively selected data, user profile active selections, selections made at a particular location, a user location active selection, time of active selections, organization of data, formats of data, data conversions, scores/rankings of data, persona data, user profile data, etc. Moreover, it is to be appreciated and understood that the history component 502 can enable collected and/or tracked data to be viewed in any suitable format, configuration, etc. and organized based on any characteristic (e.g., age, time, date, file size, file type, etc.) for optimal comprehension. For instance, the historic data can be viewed as icons, text listings, thumbnails, a graphic, a snapshot of the data, snapshot of data with established enhancements, etc.

The aggregator component 102 can additionally utilize a settings component 504 that can employ a plurality of settings, options, configurations, and the like with the system 500. The settings component 504 can include default settings pre-designated, a user-defined setting, and/or any suitable combination thereof For instance, active and explicit selection of data can be identified with a default setting such as a right-click and pull-down option (e.g., actively identify data as full-filling an interest or purpose, etc.). Yet, a user can re-define how to actively and explicitly select data with the settings component 504. For example, the default setting can be re-defined to an icon on a browser toolbar in which data can be dragged and dropped.

The settings component 504 can be utilized to set up any options with the subject innovation such as, but not limited to, active and explicit data selection, enhancements for browsing sessions, history, data retention, privacy settings, formatting of data, user profile options, formatting specifics (e.g., slide show settings, default settings, user-defined settings, etc.), aesthetic settings, security settings, hard drive space thresholds (e.g., limitation on data accumulation for active selected data, enhancement storage, etc.), persona options/configuration, scoring details, rankings options, weighting related to scoring, enhancement options/preferences (e.g., pop-up, highlight, magnify, etc.), display options (e.g., history, actively selected data, enhancements, user profiles, etc.), and/or any other configuration related to the claimed subject matter.

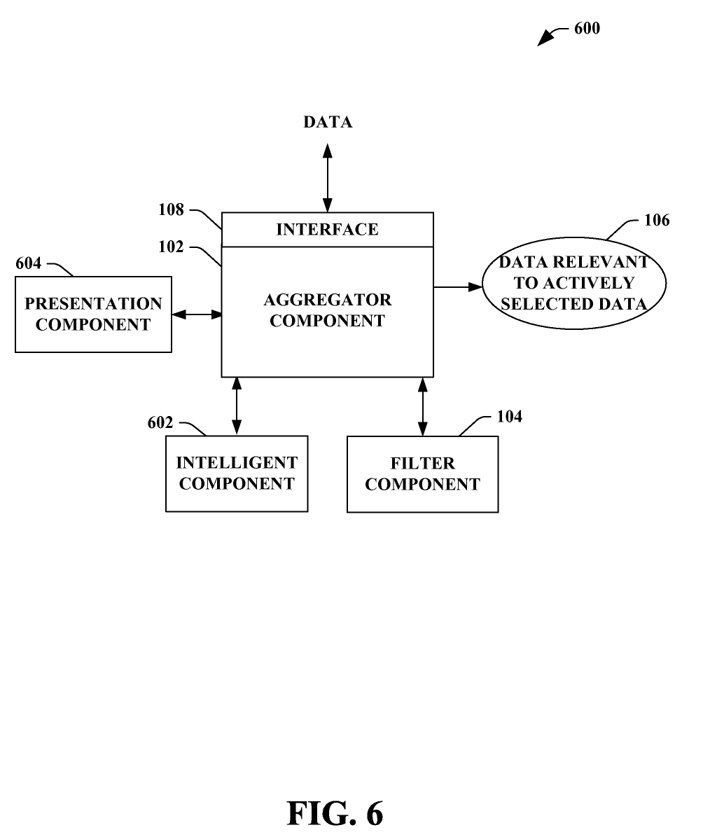

FIG. 6 illustrates a system 600 that facilitates leveraging an inference technique to optimize employment of actively and explicitly selected data. The system 600 can include the aggregator component 102, the filter component 104, data relevant to actively selected data 106, and the interface 108. It is to be appreciated that the aggregator component 102, the filter component 104, data relevant to actively selected data 106, and the interface can be substantially similar to respective components, interfaces, and relevant data described in previous figures. The system 600 further includes an intelligent component 602. The intelligent component 602 can be utilized by the aggregator component 102 to facilitate emphasizing a portion of data within a browsing session based on actively and explicitly selected data. For example, the intelligent component 602 can infer enhancements, emphasis for data, user preferences, user settings, data to enhance or emphasize, active and explicit selection options, organization aspects (e.g., formats, preferred file types, templates, etc.), scoring for data, weighting for types of data, topics, subjects, generalized topics from actively selected data, browsing session data, user profile activation, persona settings, settings, history collections, display options, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, value of information (VOI) computations, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The aggregator component 102 can further utilize a presentation component 604 that provides various types of user interfaces to facilitate interaction between a user and any component coupled to the aggregator component 102. As depicted, the presentation component 604 is a separate entity that can be utilized with the aggregator component 102. However, it is to be appreciated that the presentation component 604 and/or similar view components can be incorporated into the aggregator component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the aggregator component 102.

The user can also interact with the regions to select and provide information via various devices such as a mouse, a roller ball, a touchpad, a keypad, a keyboard, a touch screen, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

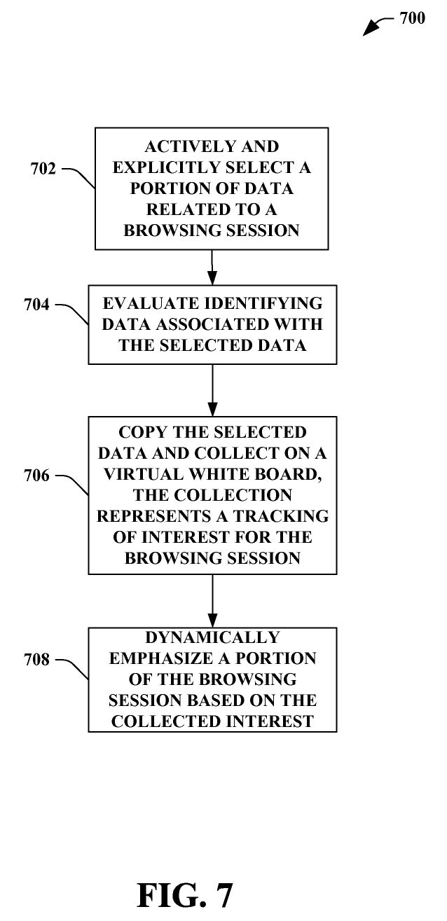

FIGS. 7-10 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a system 700 that facilitates capturing data in an original form with an active and explicit selection to dynamically identify user interests associated with data browsing. At reference numeral 702, a portion of data related to a browsing session can be actively and explicitly selected. It is to be appreciated that the browsing session can be any suitable interaction between a machine and viewable or displayed data. For example, the browsing session can be a user viewing local data (e.g., local hard drive, etc.) or remote data (e.g., the Internet, web site, etc.) on a device with a processor and memory. Within the browsing session, a portion of data can be explicitly and actively selected to order to signify that such data is of interest and/or satisfies a purpose for the browsing session. For instance, the active and explicit selection or identification can be received by a user or a machine, wherein the selection or identification can be any purposeful action that signifies the portion of data correlates to an interest or satisfies a query. In other words, data can be purposefully and actively marked (e.g., selected) upon the discovery that such data corresponds to the browsing session or if the data simply is liked. This liking or satisfaction in regards to the data can be dependent upon each controller of the browsing session. For instance, user A may like a first portion of data and can actively select such data, while user B may not like the first portion of data and can actively select a second portion of data since it is of interest to their personal tastes.

Moreover, it is to be appreciated and understood that the portion of data can be any suitable data explored, stored, or browsed on a computing device (e.g., laptop, desktop, PDA, smartphone, pocket PC, a stereo, a car stereo, an appliance, a music player, a smart device, mobile communication device, media player, gaming console, gaming device, handheld, etc.) such as, but not limited to, a web page, a portion of a web page, a selection of text, a character, a web address, an image, a portion of a graphic, an icon, a uniform resource locator (URL), a web site, a portion of a web site, a portion of handwriting, a portion of a forum, a portion of an email, a portion of a communication session (e.g., text messaging, instant messaging, a chat room, a video chat, a web chat, etc.), audio, video, live feed, a portion of data related to an application, a portion of local data (e.g., personal files, personal data, local network, local machine, local hard drive, etc.), a portion of remote data (e.g., data associated with the Internet, remote networks, etc.), and/or any other suitable data capable of being viewed, stored, or displayed.

At reference numeral 704, identifying data associated with the selected data can be evaluated. The data actively and explicitly selected on purpose can be evaluated in order to ascertain a topic or subject to which the selected data corresponds. Since the actively and explicitly selected data is indicative of an interest or a purpose within the browsing session, the evaluation of the selected data can be utilized to identify topics, details, characteristics, subjects, names, places, events, items, goods, etc. to which also satisfy an interest or purpose. Various characteristics of the selected data can be evaluated to ascertain relationships, associations, etc. such as, but not limited to, a tag (e.g., hypertext markup language (HTML), etc.), metadata, search terms, key words, source of selected data (e.g., web site, web page, address, name, file type, file name, etc.), image data, context, etc.

At reference numeral 706, the selected data can be copied and collected onto a virtual white board, wherein the collection can represent a tracking of interest for the browsing session. The selected data can be copied in original state, form, file type, etc. onto or into the virtual white board which can be a tabulated collection of data indicative of interest or satisfaction for a browsing session. Since the virtual white board can accumulate any actively and explicitly selected data, the virtual white board can be representative of data flagged as satisfying a browsing session interest, related to a purpose for the browsing session, a liking, or an appeal. The virtual white board can be edited in order to ensure that the data actively and explicitly selected is of interest and can further display a history or record of such information. In general, the virtual white board can be viewed, displayed, cleared, transmitted, communicated, stored, uploaded, downloaded, shared, etc. It is to be appreciated that such data will be much more granular and detailed in comparison to typical “favorites” or “bookmarks” since the original state (e.g., a snapshot of original state, file type, format, location, amount, type of data, etc.) and/or a portion of data (e.g., image, portion of text, a section of a web page, etc.) in addition to the entire URL can be copied to the virtual white board.

At reference numeral 708, a portion of the browsing session can be dynamically emphasized based on the collected interest. With the collected interest (e.g., the collected data on the virtual white board that has been actively and explicitly selected/identified), a portion of data within the browsing session (e.g., current or future session) can be emphasized in order to illustrate relevant data. In other words, a portion of data within a browsing session can be emphasized based in part upon such portion of data being relevant or having a relationship to the collected interest represented by the virtual white board. It is to be appreciated that the emphasis can be, but is not limited to, an exclusion of data (e.g., eliminating data in which no interest is ascertained, etc.), a highlight of data (e.g., color, highlight, shapes encompassing data, glowing, blurring of data, sharpening of data, etc.), an enlargement of data (e.g., font, size, magnification, etc.), a graphic directing attention towards data (e.g., a pop up, an arrow, an icon, a flag, etc.), a refinement of search terms, a refinement and/or adjustment of a query, and/or any other suitable technique that can discern relevant data from non-relevant data in the data browsing session.

For instance, a user can browse a sports web page in which an article is being read about a Cleveland baseball team. The user can purposefully select the text “Cleveland baseball team,” wherein such purposeful selection can be representative of declaring the user has an interest in such data (here, the user has an interest in the Cleveland baseball team since it has been approved and purposefully selected to be indicative of an interest). The portion of text can be copied in original form (e.g., in this example text in the original font, size, etc.) onto or into a virtual white board. The selected text can further be evaluated in order to extract data that can facilitate identifying other relevant data. Such evaluation of data (e.g., the examination of collected data on the virtual white board) can enable a portion of data within the browsing session to be emphasized based on a relationship, association, or having relevancy. Thus, during the browsing session, a link or article discussing a player on the Cleveland baseball team can be emphasized since it is relevant to the collected interest. It is to be appreciated that the original form of selected data can be a characteristic in which data that is to be emphasized can conform. Thus, if an image is actively selected, relevant data can be emphasized only if it is an image. For example, an image file can drive a text search. In other words, the active and explicit data selection can be an image and various articles related to such image can be returned, emphasized, enhanced, etc. in accordance with a user preference.

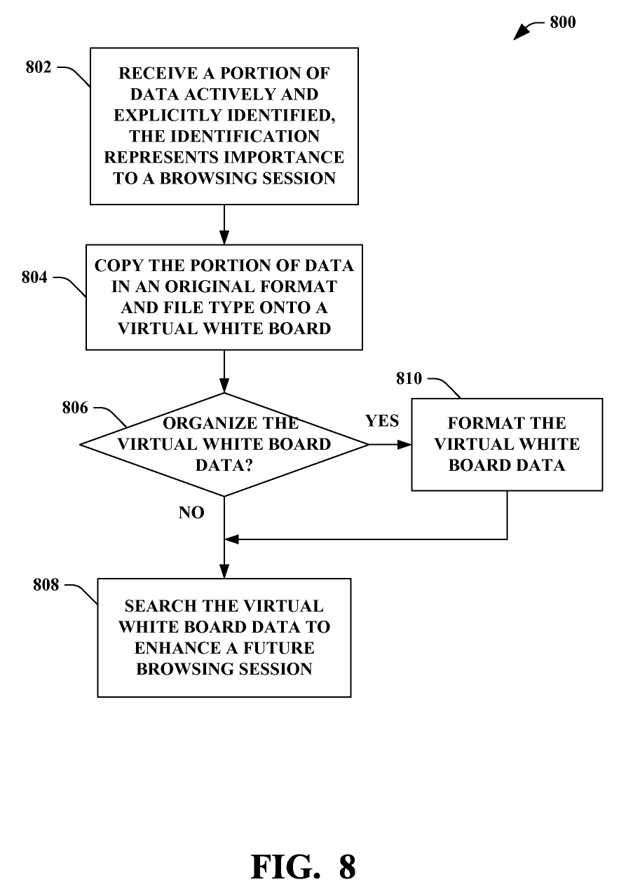

FIG. 8 illustrates a methodology 800 for collecting and organizing data of importance with an explicit selection. The methodology 800 can enable a collection of actively selected data to be uniformly formatted for enhanced usability. At reference numeral 802, a portion of data actively and explicitly identified can be received, wherein the identification represents importance to a browsing session. It is to be appreciated that the identification can be any purposeful action (e.g., clicking, designated button inputs from an input device, graphical overlays, eye detection, voice commands, touching, flagging, a body motion of a user, underlining, highlighting, bolding, font-change, font size, color-change, selection tools, selection modes, etc.) that signifies the portion of data correlates to an interest or satisfies a query. At reference numeral 804, the portion of data can be copied in an original format, state, and file type onto or into a virtual white board.

Referring to reference numeral 806, a determination can be made whether the virtual white board data is to be organized. The determination can be made based at least in part upon a user preference, a user profile, a setting, a default setting, a configuration, a user, a format associated with the originally captured (e.g., selected) data, etc. If the virtual white board data is to be organized (e.g., YES), the method 800 can continue to reference numeral 810. At reference numeral 810, the virtual white board data can be formatted. The virtual white board data (e.g., the selected data) can be formatted to be converted into various data representations such as, but not limited to, a URL, a thumbnail, an icon, a web address, a web page, an image, a slide show, a word processing document, a presentation, an application specific file type (e.g., a portable document format (PDF), etc.), an email attachment, a text message, a short messaging service (SMS) message, an instant message, a compressed file package, a portion of video, a portion of audio, a downloadable file format, a voicemail, and/or any suitable combination thereof. In addition, various configuration and details associated with the data representation can be formatted as well (e.g., font, page layout, templates, etc.). In general the virtual white board data can be converted from an original captured format into a user-defined or preferred format. By allowing white board data to be uniformly formatted, such data can be efficiently used in research, presentations, personal use, emailing, communication, spread sheets, hard-copy distribution, and/or any other application or software uses for such interest-representing data. Once the format is complete, the method 800 can continue to reference numeral 808 (discussed below).

If the virtual white board data is not to be organized (e.g., NO), the method 800 continues to reference numeral 808. At reference numeral 808, the virtual white board data can be searched to enhance a future browsing session. It is to be appreciated that virtual white board data can be searched to identify a topic, a subject, identifying metadata, relationships, associations, etc. The virtual white board data can be searched in order to enhance the browsing session (e.g., current or future) by emphasizing a portion of relevant data, wherein relevancy is based upon the search.

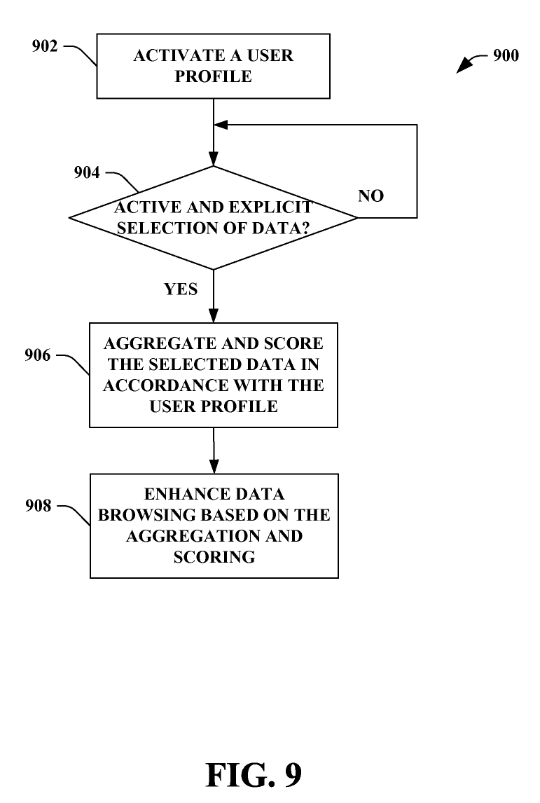

FIG. 9 illustrates a methodology 900 that facilitates managing a data browsing session towards an interest of a particular user or machine based on previously collected data. The methodology 900 can effectuate the use of user profiles in order to manage actively and explicitly collected data. At reference numeral 902, a user profile can be activated. In particular, the user profile can be activated as well as a specific role or persona which further characterizes the manner in which a user will be exploring, viewing, browsing, or utilizing data. For instance, a user profile can exist for any user or machine that can utilize a device for a browsing session. Moreover, the user profile can include personas or roles that granularly define an activated user profile. The persona or role can be based on a location, a time of data, a season, a machine, a network, a service provider, a connection (e.g., wireless, LAN, etc.), a connection speed, etc.

At reference numeral 904, a determination is made whether or not there has been an active and explicit selection of data. It is to be appreciated that the identification or selection can be any purposeful action (e.g., clicking, designated button inputs from an input device, graphical overlays, eye detection, voice commands, touching, a body motion, flagging, underlining, highlighting, bolding, font-change, font size, color-change, selection tools, selection modes, etc.) that signifies the portion of data correlates to an interest or satisfies a query. If there has not been an active and explicit selection of data (e.g., NO), the method 900 can continue to await such selection. If there has been an active and explicit selection of data (e.g., YES), the method 900 can continue to reference numeral 906.

At reference numeral 906, the selected data can be aggregated and scored in accordance with the user profile. The selected data can be scored by employing a weighting technique towards the actively and explicitly data. In other words, a granular weighting technique can be utilized to calculate an amount of impact a portion of selected data can have on identifying relevant data at reference numeral 908. Such scoring and aggregation of data can be in accordance with an activated user profile. At reference numeral 908, data browsing can be enhanced based on the aggregation and scoring for the activated user profile.

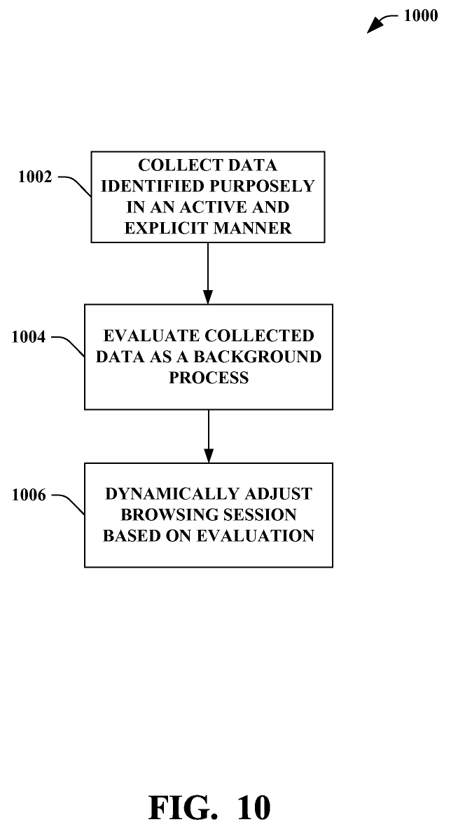

FIG. 10 illustrates a methodology 1000 for dynamically refining a browsing experience based on active explicit identification of user-interested data. At reference numeral 1002, data can be identified purposely in an active and explicit manner. At reference numeral 1004, the collected data can be evaluated as a background process. For instance, various characteristics of the collected data can be examined, monitored, and/or tracked in order to identify relationships, associations, themes, subjects, topics, similarities, etc. At reference numeral 1006, a browsing session can be dynamically adjusted based on the evaluation. For instance, the adjustment can be, but is not limited to being, a refinement of search terms, a refinement and/or adjustment of a query, an exclusion of data (e.g., eliminating data in which no interest is ascertained, etc.), a highlight of data (e.g., color, highlight, shapes encompassing data, glowing, blurring of data, sharpening of data, etc.), an enlargement of data (e.g., font, size, magnification, etc.), a graphic directing attention towards data (e.g., a pop up, an arrow, an icon, a flag, etc.), and/or any other suitable technique that can discern relevant data from non-relevant data in the data browsing session.

In still another example, the method 1000 can be utilized in identifying a portion of data actively and explicitly selected as not satisfying an interest, purpose, or a search query. For instance, a user can actively and purposely actively select data that the does not appeal or is of no interest to the user. Thus, the method 1000 can automatically evaluate such actively and explicitly selected data to emphasize and/or enhance a browsing session. In particular, data that is relevant to the selected that that is of no interest to the user can be blocked or de-emphasized (e.g., smaller font, blocked, eliminated, shrunk, blurred, etc.).

In yet another aspect of the subject innovation, the active and explicit selection of data can be ranked by the user in order to specify an amount of interest (e.g., relevancy, appeal, satisfaction, etc.) or disinterest (e.g., irrelevancy, non-appealing, dissatisfaction, etc.). Thus, upon an active and explicit data selection, a user can rank on any suitable scale the degree to which such data should be weighted, ranked or utilized in identifying relevant data within a browsing session. In other words, the user can define an amount of influence a particular active and explicit selection can have for emphasizing on a browsing session.

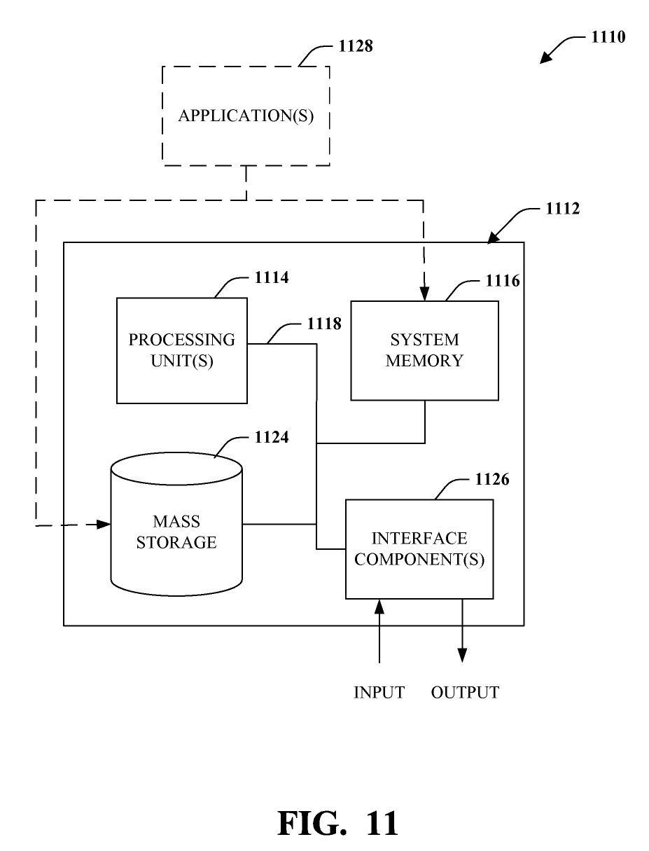

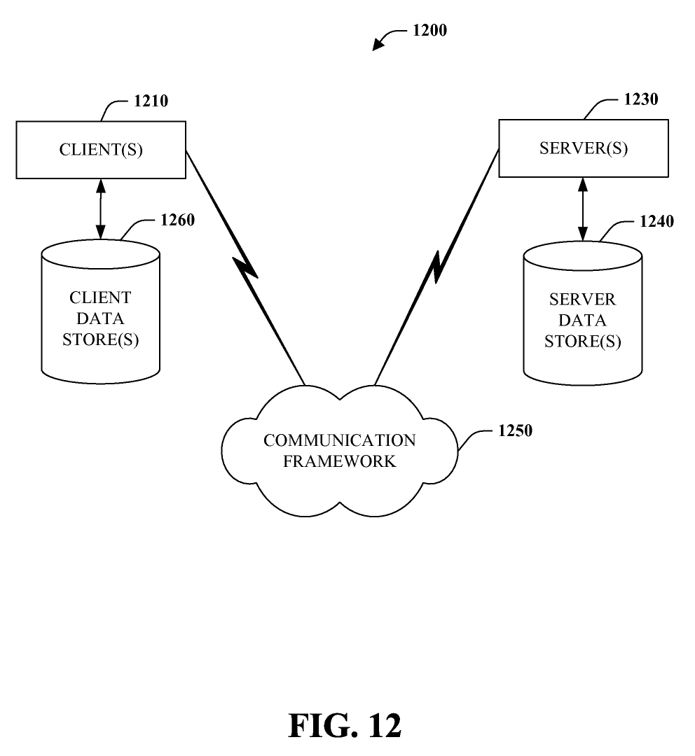

In order to provide additional context for implementing various aspects of the claimed subject matter, FIGS. 11-12 and the following discussion is intended to provide a brief, general description of a suitable computing environment in which the various aspects of the subject innovation may be implemented. For example, an aggregator component that can accumulate a portion of actively selected data in which the active selection is indicative of an interest to enable a filter component to influence a browsing session, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116, and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire, etc.) or an interface card (e.g., sound, video, network, etc.) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g., CRT, LCD, plasma, etc.), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as wholly in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A computer-implemented data browsing system that facilitates accumulating a portion of data associated with an interest, comprising:
an interface component that receives a portion of data actively and explicitly selected by an input device during a browsing session, the selection is indicative of an interest experienced during the browsing session;
an aggregator component that copies the portion of data upon active and explicit selection, the portion of data is accumulated as a collection representative of the interest; and
a filter component that manipulates the browsing session to emphasize a portion of data based on having relevancy to the collection representative of the interest.

2. The system of claim 1, the selected data is purposely and knowingly selected by at least one of a user or a machine as being at least one of relevant, important, or appealing, the selection is at least one of a clicking, a designated button input from an input device, a graphical overlay that can receive the selection, an eye detection, a voice command, a touching, a touch screen input, a flagging, an underlining, a highlighting, a bolding, a font-change, a font size, a color-change, a selection tool, or a selection mode.

3. The system of claim 1, the portion of data is at least one of a portion of data explored, a portion data browsed, a web page, a portion of a web page, a selection of text, a character, a web address, an image, a portion of a graphic, an icon, a uniform resource locator (URL), a web site, a portion of a web site, a portion of handwriting, a portion of a forum, a portion of an email, a portion of a communication session, a text message, an instant message, a chat room, a video chat, a web chat, a portion of audio, a portion of video, a portion of a live feed, a portion of data related to an application, a portion of local data, a personal file, a personal data, a local network, a local machine, a local hard drive, a portion of remote data, a portion of data associated with the Internet, a remote network, or a portion of data that is displayed on a machine.

4. The system of claim 1, at least one of the interface, the aggregator component or the filter component are utilized in connection with a device, the device is at least one of a computer, a laptop, a machine, a cell phone, a handheld, a smartphone, a portable digital assistant (PDA), a mobile communication device, a gaming device, a pocket PC, a cellular device, a wireless device, a mobile Internet browsing device, a portable media player, a portable PC, a gaming console, or a gaming device.

5. The system of claim 1, the accumulated collection is stored onto a virtual white board in which the collection is stored in at least one of an original state, an original data representation, or original file type upon active and explicit selection.

6. The system of claim 5, the virtual white board is at least one of viewed, displayed, cleared, transmitted, stored, uploaded, downloaded, or shared.

7. The system of claim 5, further comprising an organizer component that formats the collected data from an original data representation to a disparate data representation, the organizer component manages a configuration related to the data representation.

8. The system of claim 5, the data representation is at least one of a URL, a thumbnail, an icon, a web address, an image, a slide show, a word processing document, a presentation, an application specific file type, a portable document format (PDF), an email attachment, a text message, a short messaging service (SMS) message, an instant message, a compressed file package, a portion of video, a portion of audio, a downloadable file format, or a voicemail.

9. The system of claim 1, the selected data is identified with an input device, the input device is at least one of a mouse, a trackball, a voice receiver, a voice component, an eye detection component, an eye detection receiver, a touch-screen, a touch pad, a keyboard, a keypad, a joystick, a movement sensor, or a movement component.

10. The system of claim 1, the filter component evaluates at least one of a tag, a hypertext markup language (HTML), a portion of metadata, a search term, a key word, a source of selected data, a portion of image data, or a context in order to emphasize the portion of data within the browsing session.

11. The system of claim 1, the emphasis within the browsing session is at least one of an exclusion of data, an elimination of data, a highlight of data, a color change, a highlight, a shape to encompass data, a glow, a blur, a sharpening of data, an enlargement of data, a change in font, a change in size, a magnification, a graphic directing attention towards data, a pop up, an arrow, an icon, a flag, a refinement of a search term, or an adjustment of a query.

12. The system of claim 1, further comprising a score component that employs at least one of a weighting towards the selected portion of data to measure an amount of interest or a distinct score for the portion of data actively selected in which the distinct score relates to measuring an amount that the selected data satisfies the interest.

13. The system of claim 12, the score component utilizes a weight template for the weighting, the weight template is at least one of user-defined, default-defined, or pre-defined.

14. The system of claim 1, further comprising a user profile that tracks user activity within the browsing session, the user profile includes one or more personas.

15. They system of claim 14, the persona is based on at least one of a location, a time, a season, a device, a network connection, a server, a connection type, a connection speed, a GPS identified location, or a service provider.

16. The system of claim 1, further comprising a history component that tracks at least one of an active and explicit data selection, an emphasis made to the browsing session, a portion of data viewed, a portion of data displayed, a portion of data identified by a user, a portion of data of interest to a user, a portion of data relevant to actively selected data, a user profile active selection, a user profile history, a persona within a user profile history, an organization of data, a format of data, a data conversion, an original state of a portion of data, an original data representation, an original file type of a portion of data, a selections made at a particular location, a user location active selection, or a score of a portion of data.

17. A computer-implemented method that facilitates emphasizing a portion of data identified to represent an interest during a browsing session, comprising:
actively and explicitly selecting a portion of data related to a browsing session;
evaluating identifying data associated with the selected portion of data;
copying the selected portion of data onto a virtual white board;
determining at least one of an interest or a disinterest based upon analyzing at least one of the collection of data on the virtual white board or the identifying data; and
dynamically emphasizing a portion the browsing session based upon the analysis.

18. The method of claim 17, further comprising:
organizing the selected portion of data on the virtual white board;
formatting the selected portion of data into a data representation;
managing a configuration associated with the data representation;
receiving a user ranking of the actively and explicitly selected data to ascertain a degree of at least one of interest or disinterest; and
performing a search on the selected portion of data as a background process.

19. The method of claim 17, further comprising:
activating a user profile;
activating a persona associated with the user profile;
scoring the selected portion of data for the activated user profile; and
utilizing a scoring template with defined weights for measuring interest.

20. A computer-implemented system that facilitates optimizing a browsing session to reduce data irrelevant to a user, comprising:
means for receiving a portion of data actively and explicitly selected by an input device during a browsing session, the selection is indicative of an interest experienced during the browsing session;
means for copying the portion of data upon active and explicit selection;
means for evaluating the portion of selected data to ascertain the interest;
means for emphasizing a portion of data within the browsing session based on the evaluation.
